(19) United States
(12) Patent Application Publication
(10) Pub. No.: US 2011/0082252 A1
(43) Pub. Date: Apr. 7, 2011

(54) COUPLED POLYESTER ACRYLATE GRAFT POLYMERS

(75) Inventors: Rene Koschabek, Weinheim (DE); Gabriele Brenner, Duelmen (DE); Cornelia Borgmann, Frankfurt (DE); Hartmut Alt, Brachttal (DE); Sven Balk, Frankfurt (DE)

(73) Assignee: EVONIK DEGUSSA GMBH, ESSEN (DE)

(21) Appl. No.: 12/992,184

(22) PCT Filed: Jun. 22, 2009
(86) PCT No.: PCT/EP09/57720

§ 371 Date: Nov. 11, 2010

(30) Foreign Application Priority Data
Jul. 16, 2008 (DE) 10 2008 040 464.0

(51) Int. Cl. C08G 81/02; C09D 133/14

(52) U.S. Cl. 524/558; 525/386

(57) ABSTRACT

The present invention relates to polyester acrylate graft copolymers comprising poly(meth)acrylates as graft substrate, the graft substrate having internal and/or terminal functional groups and polyester side chains as graft branches and/or having polyester blocks attached to at least one chain end of the graft substrate. The present invention further relates to processes for preparing the polyester acrylate graft copolymers and also to their use.

The present invention relates to polyester acrylate graft copolymers comprising poly(meth)acrylates as graft substrate, the graft substrate having internal and/or terminal functional groups and polyester side chains as graft branches and/or having polyester blocks attached to at least one chain end of the graft substrate. The present invention further relates to processes for preparing the polyester acrylate graft copolymers and also to their use.

The synthesis of polymer architectures which are based on a combination of polyesters and poly(meth)acrylates has been a subject of industrial research since as long ago as the middle of the 1960s. The potential applications of such materials include, for example, dispersants (see EP 1 555 174, for example), impregnating compositions (GB 1,007,723), binders for coatings (described in DE 2 006 630, JP 09 216 921 or DE 4 345 086, for example) or for adhesives (in DE 2 006 630, for example).

The possibilities of the targeted combination of poly(meth)acrylates and polyesters are diverse. For instance, systems comprising polyester main chains and (meth)acrylate side chains are known from DE 4427227.

In order to arrive at polymer architectures which have a poly(meth)acrylate main chain and polyester side chains it is generally customary to use polyesters which can be obtained by ring-opening polymerization of lactones. For example, EP 1227113 describes the ring-opening polymerization of ε-caprolactone by hydroxyl-functional monomeric acrylate compounds—hydroxyethyl acrylate for example. The products of this reaction can then be subjected to free-radical copolymerization, for example, with other unsaturated compounds. This method, though, can be carried out only with a small amount of ε-caprolactone.

A further method (in JP 06206974, for example) involves first reacting ε-caprolactone to form the homopolymer and then coupling it to a polyacrylate polyol by means of a diisocyanate or polyisocyanate. In this way it is possible to obtain very defined products with a low homopolymer fraction. A disadvantage of this process is the high technical expenditure occasioned by the separate preparation of the individual polymer blocks and their subsequent coupling by means of an isocyanate component. Moreover, the handling of isocyanates is problematic from both economic and toxicological standpoints.

A further method of obtaining comblike polymers with a poly(meth)acrylate main chain and ester side chains is described by EP 1464674. It discloses the free-radical polymerization of ε-caprolactone-modified vinyl monomers. These are ε-caprolactone oligomers which can be obtained by ring-opening oligomerization using hydroxy (meth)acrylates such as hydroxybutyl (meth)acrylate, for example. The ε-caprolactone-modified vinyl monomers are sold commercially by, for example, Daicel Chemical Industries under the brand name Placcel F. This method is complicated and therefore costly. The purification of the macromonomers is very complicated. In addition it is found that such macromonomers are available only to a very limited extent with a maximum number of 10 repeating caprolactone units. The correspondingly short ester side chains of the resultant poly(meth)acrylate hence also have only a limited influence on the properties of the polymer.

EP 281095 describes the simultaneous main chain and side chain polymerization. It utilizes acrylate monomers which possess nucleophilic functionalities and which, propagated during the construction of the main chain, initiate side-chain construction through ring opening of lactones. This, however, is an uncontrolled process, which leads to product mixtures with a multiplicity of very different components such as homopolymers, for example. An inevitable consequence of this for the person skilled in the art is that, under the conditions of an ionic lactone polymerization, the free radical polymerization that is carried out in situ inevitably leads to secondary reactions such as partial gelling of the products. Instances of crosslinking of this kind, however, are of great disadvantage for the processing of the product, even in the case where they occur only to a low level. A further disadvantage of the use of lactones is that, owing to the linear aliphatic structure of the polyester chains, the glass transition point of the polymers is, for many applications, too low.

The purely aliphatic structure of the polylactone side chains may also lead, furthermore, to compatibility problems affecting the preparation of polymer mixtures.

It may also be necessary, for certain applications, such as paints and adhesives, for example, to dissolve the polymers in organic solvents. In that case it is worthwhile to set the desired solubility in the solvent in question through a targeted selection of raw materials for the poly(meth)acrylate main chain, but also for the polyester side chain.

It was an object of the present invention, accordingly, to provide polyester-poly(meth)acrylate systems which serve as compatibilizers between poly(meth)acrylates and polyesters and which avoid the disadvantages identified above.

This complex profile of requirements is fulfilled, surprisingly, by the graft copolymers of the invention. Accordingly the present invention first provides polyester acrylate graft copolymers comprising poly(meth)acrylates as graft substrate, the graft substrate having internal and/or terminal functional groups and polyester side chains as graft branches and/or having polyester blocks attached to at least one chain end of the graft substrate.

Graft copolymers for the purposes of the present invention are polymers in which side chains are attached to the main chain that are of a length such that they can already be considered to be polymers per se. The main chain of the graft copolymers is referred to in general as the backbone polymer, graft substrate or graft base, the side chains being referred to generally as graft branches or grafts.

The polyester acrylate graft copolymers of the invention are distinguished by a polyester poly(meth)acrylate polymer architecture of brushlike construction, having a poly(meth)acrylate backbone and polyester side chains, the polyester side chains not being produced by ring-opening polymerization of lactones.

The advantage of a polymer of this kind is the much more multi-faceted spectrum of use, resulting from the free selectability of the polyesters and/or poly(meth)acrylates used and their respective raw materials. In this context it has surprisingly been found that polyester poly(meth)acrylate polymer architectures of this kind can be obtained, without gelling, in which carboxyl- and/or hydroxyl-bearing polyesters are grafted couplingly onto poly(meth)acrylates which contain monomers having functional groups.

The amount of monomers having functional groups in the poly(meth)acrylates of the invention is in the range from 0.1% and 10% by weight, preferably between 0.1% and 5.0% by weight, more preferably between 1.0% to 2.5% by weight, based on the poly(meth)acrylate fraction in the polyester acrylate graft copolymer.

Poly(meth)acrylates are used as graft substrates in the present invention. The poly(meth)acrylates are based on monomers, more particularly on monomers which carry functional groups. Such monomers may be selected from the group of the methacrylates and acrylates. Examples of functional groups are nucleophilic groups in particular. The functional groups are selected preferably from the group encompassing hydroxyl groups, acid groups, amino groups and/or mercapto groups.

The functional group is preferably a hydroxyl group or an acid group. With particular preference the functional group is a hydroxyl group.

With particular preference the functional group is introduced by copolymerization of OH-containing monomers into the poly(meth)acrylate that is used in accordance with the invention. OH-functionalized acrylates and/or methacrylates are particularly preferred. Examples include hydroxyethyl methacrylate, hydroxyethyl acrylate, hydroxypropyl methacrylate, hydroxypropyl acrylate, 2,3-dihydroxypropyl acrylate and 2,3-dihydroxypropyl methacrylate.

Alternatively or additionally it is possible to incorporate OH groups into poly(meth)acrylates by means of regulators that are used. Where such a regulator is used, and in the case of subsequent coupling with the polyester, AB diblock copolymers and/or ABA triblock copolymers are formed. The A blocks in this case are the poly(meth)acrylate blocks, and the B block is a polyester block, which prior to coupling to an AB diblock copolymer contains at least one terminal carboxyl group or, in the case of coupling to an ABA triblock copolymer, contains two terminal carboxyl groups.

In combination with OH-functionalized monomers, graft copolymers having an additional polyester block on one of the polymethacrylate chain ends are formed.

Particularly preferred regulators carrying OH groups include hydroxyl-functionalized mercaptans and/or other functionalized or else unfunctionalized compounds which contain one or more thiol groups and hydroxyl groups. These compounds may be, for example, mercaptoethanol, mercaptopropanol, mercaptobutanol, mercaptopentanol or mercaptohexanol.

Coupled to the functional groups, especially OH groups, of the graft substrate are the terminal acid end groups of a polyester.

The poly(meth)acrylate prepolymers used, i.e. the ungrafted graft substrates, preferably have an OH number of between 5 mg KOH/g and 40 mg KOH/g, more preferably between 10 mg KOH/g and 35 mg KOH/g and with particular preference between 15 mg KOH/g and 30 mg KOH/g.

The hydroxyl number (OH number) is determined in accordance with DIN 53240-2.

Alternatively the functional groups may also be acid groups. These groups are incorporated into the chain by copolymerization of an acid, by copolymerization of a monomer which can subsequently be converted polymer-analogously to an acid, or by use of an acid-containing regulator. In the case of the copolymerizable acids, the acids in question may be acrylic acid, methacrylic acid or itaconic acid, for example. In the case of the polymer-analogously reactable building blocks, the compounds in question may be, for example, tert-butyl methacrylate or tert-butyl acrylate, which are able to form an acid group under hot conditions with elimination of isobutene. In the case of the regulators containing acid groups, thioglycolic acid serves as a customary example.

In this embodiment the terminal OH groups of a polyester are coupled to the acid groups of the graft substrate.

The poly(meth)acrylate prepolymers that are used for this variant preferably have an acid number of between 5 mg KOH/g and 40 mg KOH/g, more preferably between 10 mg KOH/g and 35 mg KOH/g and with particular preference between 15 mg KOH/g and 30 mg KOH/g.

The acid number is determined in accordance with DIN EN ISO 2114.

Further to the building blocks which carry functional groups, the poly(meth)acrylates used in accordance with the invention are composed of monomers selected from the group consisting of (meth)acrylates such as, for example, alkyl (meth)acrylates of straight-chain, branched or cycloaliphatic alcohols having 1 to 40 C atoms, such as methyl (meth)acrylate, ethyl (meth)acrylate, n-butyl (meth)acrylate, i-butyl (meth)acrylate, t-butyl (meth)acrylate, pentyl (meth)acrylate, 2-ethylhexyl (meth)acrylate, stearyl (meth)acrylate, lauryl (meth)acrylate, cyclohexyl (meth)acrylate and isobornyl (meth)acrylate, for example; aryl (meth)acrylates such as, for example, benzyl (meth)acrylate or phenyl (meth)acrylate, each of which may have aryl radicals which are unsubstituted or substituted 1-4 times; other aromatically substituted (meth)acrylates such as, for example, naphthyl (meth)acrylate; mono(meth)acrylates of ethers, polyethylene glycols, polypropylene glycols or mixtures thereof having 5-80 C atoms, such as tetrahydrofurfuryl methacrylate, for example, methoxy(m)ethoxyethyl methacrylate, 1-butoxypropyl methacrylate, cyclohexyloxymethyl methacrylate, benzyloxymethyl methacrylate, furfuryl methacrylate, 2-butoxyethyl methacrylate, 2-ethoxyethyl methacrylate, allyloxymethyl methacrylate, 1-ethoxybutyl methacrylate, 1-ethoxyethyl methacrylate, ethoxymethyl methacrylate, poly(ethylene glycol) methyl ether (meth)acrylate and poly(propylene glycol) methyl ether (meth)acrylate, together.

As well as the (meth)acrylates set out above, the compositions to be polymerized may also contain further unsaturated monomers which are copolymerizable with the aforementioned (meth)acrylates and by means of free-radical polymerization. Such monomers include, among others, 1-alkenes, such as 1-hexene, 1-heptene, branched alkenes such as, for example, vinylcyclohexane, 3,3-dimethyl-1-propene, 3-methyl-1-diisobutylene, 4-methyl-1-pentene, acrylonitrile, vinyl esters such as vinyl acetate, styrene, substituted styrenes having an alkyl substituent on the vinyl group, such as α-methylstyrene and α-ethylstyrene, for example, substituted styrenes having one or more alkyl substituents on the ring, such as vinyltoluene and p-methylstyrene, halogenated styrenes such as, for example, monochlorostyrenes, dichlorostyrenes, tribromostyrenes and tetrabromostyrenes; heterocyclic compounds such as 2-vinylpyridine, 3-vinylpyridine, 2-methyl-5-vinylpyridine, 3-ethyl-4-vinylpyridine, 2,3-dimethyl-5-vinylpyridine, vinylpyrimidine, 9-vinylcarbazole, 3-vinylcarbazole, 4-vinylcarbazole, 2-methyl-1-vinylimidazole, vinyloxolane, vinylfuran, vinylthiophene, vinylthiolane, vinylthiazoles, vinyloxazoles and isoprenyl ethers; maleic acid derivatives, such as maleic anhydride, maleimide, methylmaleimide, for example, and dienes such as divinylbenzene, for example, and also, in the A blocks, the respective hydroxyl-functionalized and/or amino-functionalized and/or mercapto-functionalized compounds. Furthermore, these copolymers may also be prepared such that they have a hydroxyl and/or amino and/or mercapto functionality in a substituent. Such monomers are, for example, vinylpiperidine, 1-vinylimidazole, N-vinylpyrrolidone, 2-vinylpyrrolidone, N-vinylpyrrolidine, 3-vinylpyrrolidine, N-vinylcaprolactam, N-vinylbutyrolactam, hydrogenated vinylthiazoles and hydrogenated vinyloxazoles. Particular preference is given to copolymerizing vinyl esters, vinyl ethers, fumarates, maleates, styrenes or acrylonitriles with the A blocks and/or B blocks.

The poly(meth)acrylate prepolymers of the invention preferably have a molecular weight M_{w} of between 1000 and 200000 g/mol. Particular preference is given to a molecular weight M_{w} of between 5000 and 100000 g/mol, and very particular preference to a molecular weight M_{w} of between 10000 and 50000 g/mol.

The weight average of the molecular weight, M_{w}, is determined by means of gel permeation chromatography with IR detection in accordance with DIN 55672-1, with tetrahydrofuran as eluent against a polystyrene standard.

Specifically the poly(meth)acrylate is advantageously selected, in terms of proportion and composition, with regard to the desired technical function.

The poly(meth)acrylates used in accordance with the invention may be prepared by means of bulk, emulsion, suspension, minisuspension or microsuspension or solution polymerization. The polymerization process used may be a free-radical or controlled-growth radical polymerization. Examples of controlled-growth radical polymerization processes are nitroxide mediated polymerization (NMP) and reversible addition-fragmentation chain transfer (RAFT) polymerization.

The free-radical initiators to be used are dependent on the selected polymerization method or polymerization technology. The particular initiators to be used are known to a person skilled in the art and/or are described in the polymer literature that is general knowledge to a person skilled in the art. As an example, in free-radical solution or suspension polymerization, it is common to use azo compounds such as AIBN or peresters such as tert-butyl peroctoate or lauryl peroxide as the free-radical initiator.

Where appropriate, in order to adjust the desired molecular weight of the graft substrate A, it is additionally possible to use regulators as well. Examples of suitable regulators include sulphur regulators, especially regulators containing mercapto groups, e.g. dodecyl mercaptan. The concentrations of regulators are generally 0.1% by weight to 2.0% by weight, based on the total polymer.

The polyesters which are used as graft branches in the present invention have a linear or branched structure and are characterized by
a number-average molecular weight Mₙ of 500 to 10000 g/mol, preferably 800 to 3000 g/mol
an acid number of 1 to 100 mg KOH/g, preferably of 5 to 70 mg KOH/g, very preferably 20 to 60 mg KOH/g
a hydroxyl number of between 1 and 200 mg KOH/g, preferably between 10 and 100 mg KOH/g, very preferably 20 and 60 mg KOH/g.

The number average of the molecular weight, Mₙ, is determined by means of gel permeation chromatography with IR detection, in accordance with DIN 55672-1, with tetrahydrofuran as eluent against the polystyrene standard. The acid number is determined in accordance with DIN EN ISO 2114. The hydroxyl number (OH number) is determined in accordance with DIN 53240-2.

The polyesters used in accordance with the invention are synthesized generally by polycondensation of polycarboxylic acids and polyols. Alternatively, however, they can also be prepared by means of ring-opening polymerization of cyclic esters or by polyaddition.

The choice of the polycarboxylic acids per se is arbitrary. Thus it is possible for aliphatic and/or cycloaliphatic and/or aromatic polycarboxylic acids to be present. Polycarboxylic acids are compounds which preferably carry more than one and with particular preference two carboxyl group(s); deviating from the general definition, monocarboxylic acids are included as well in particular embodiments.

Examples of aliphatic polycarboxylic acids are succinic acid, glutaric acid, adipic acid, azelaic acid, sebacic acid, undecanedicarboxylic acid, dodecanedioic acid, tridecanedicarboxylic acid, tetradecanedioic acid, and octadecanedioic acid. Examples of cycloaliphatic polycarboxylic acids are the isomers of cyclohexanedicarboxylic acid. Examples of aromatic polycarboxylic acids are the isomers of benzenedicarboxylic acid and trimellitic acid. Where appropriate, in lieu of the free polycarboxylic acids, it is also possible to use their esterifiable derivatives, such as, for example, corresponding lower alkyl esters or cyclic anhydrides.

The nature of the polyols used for the polyesters of the invention is arbitrary per se. Thus aliphatic and/or cycloaliphatic and/or aromatic polyols may be present. Polyols are compounds which carry preferably more than one and with particular preference two hydroxyl group(s); deviating from the general definition, they also include monohydroxy compounds in particular embodiments.

Examples of polyols are ethylene glycol, propane-1,2-diol, propane-1,3-diol, butane-1,4-diol, pentane-1,5-diol, hexane-6-diol, nonane-1,9-diol, dodecane-1,12-diol, neopentylglycol, butylethylpropane-1,3-diol, methylpropane-1,3-diol, methylpentanediols, cyclohexanedimethanols, trimethylolpropane, pentaerythritol and mixtures thereof.

Aromatic polyols are reaction products of aromatic polyhydroxy compounds, such as hydroquinone, bisphenol A, bisphenol F, dihydroxynaphthalene, etc., for example, with epoxides such as ethylene oxide or propylene oxide, for example. As polyols it is also possible for ether diols to be present, i.e. oligomers and/or polymers, based for example on ethylene glycol, propylene glycol or butane-1,4-diol. Linear aliphatic glycols are particularly preferred.

The polyesters used in accordance with the invention can be prepared by means of established technologies for (poly)condensation reactions. They can be obtained, for example, by condensation of polyols and polycarboxylic acids or their esters, anhydrides or acid chlorides in an inert gas atmosphere at temperatures from 100 to 270° C., preferably of 130 to 240° C., in the melt or in azeotropic regime, as described, for example, in Methoden der Organischen Chemie (Houben-Weyl), vol. 14/2, 1-5, 21-23, 40-44, Georg Thieme Verlag, Stuttgart, 1963, in C. R. Martens, Alkyd Resins, 51-59, Reinhold Plastics Appl., Series, Reinhold Publishing Comp., New York, 1961, or in DE-OSS 27 35 497 and 30 04 903. Selectively the polyesters may be without or may be equipped with regime assistants or additives, such as antioxidants, for example.

In one particular embodiment, carboxyl-bearing polyesters are obtained by reacting hydroxyl-containing polyesters, obtained by the process described above, with stoichiometric amounts of dicarboxylic anhydrides. The reaction can be carried out virtually quantitatively at temperatures of 120 to 180° C. Examples of suitable dicarboxylic anhydrides are succinic anhydride, phthalic anhydride, hexahydrophthalic anhydride, maleic anhydride, trimellitic anhydride and/or adipic anhydride.

The present invention further provides processes for preparing the polyester acrylate graft copolymers of the invention, comprising the coupling grafting of polyesters to a graft substrate, the graft substrate comprising poly(meth)acrylates having internal and/or terminal functional groups, with formation of polyester side chains as graft branches and/or with formation of polyester blocks attached to at least one chain end of the graft substrate. The polyester chains are generated by coupling grafting of carboxyl- and/or hydroxyl-bearing polyesters onto the functional groups of the poly(meth)acrylate backbone.

The polyester acrylate graft copolymers according to the invention can be prepared by means of established technologies for (poly)condensation reactions. They can be obtained, for example, by esterification of polyesters carrying hydroxyl and/or carboxyl groups with poly(meth)acrylates which contain monomers having nucleophilic groups in an inert gas atmosphere at temperatures from 50° C. to 240° C., preferably of 130 to 200° C., in the melt or in azeotropic regime. Selectively the polyester acrylate graft copolymers may be without or may be equipped with regime assistants or additives, such as antioxidants, for example.

The process of the invention can be employed with different process embodiments. For instance, in one embodiment, the polyester and the poly(meth)acrylate can each be prepared separately and isolated, and then reacted jointly in the process of the invention. In the simplest embodiment, preferably when the polyester used in accordance with the invention is prepared in the melt, the poly(meth)acrylate is added to the freshly synthesised polyester. This prevents an additional heating step for the coupling grafting.

The amounts of polyester used for the coupling grafting are between 10 and 90 parts by weight, preferably between 20 and 80 parts by weight and very preferably between 30 and 70 parts by weight, based on the polyester acrylate graft copolymer.

The amounts of poly(meth)acrylate used for the coupling grafting are between 10 and 90 parts by weight, preferably between 20 and 80 parts by weight and very preferably between 30 and 70 parts by weight, based on the polyester acrylate graft copolymer.

The polyester acrylate graft copolymer may have a weight-average molecular weight M_{w} of 2000 and 250000 g/mol, preferably 7000 and 150000 g/mol and very preferably between 12000 and 75000 g/mol.

The weight-average molecular weight M_{w} is determined by means of gel permeation chromatography with IR detection in accordance with DIN 55672-1, with tetrahydrofuran as eluent against a polystyrene standard.

There is a broad field of application for the graft copolymers and block copolymers of the invention. The selection of the use examples is not such as to restrict the use of the polymers of the invention. The examples are intended to serve solely to illustrate the broad usefulness of the polymers described.

Accordingly, the present invention further provides for the use of the polyester acrylate graft copolymers of the invention in hotmelt adhesives, adhesive-bonding compositions, sealants, pressure-sensitive adhesives or heat-sealing compositions. In such adhesive formulations the polyester acrylate graft copolymers of the invention can be used as compatibilizers. On the basis of the polymer compatibility of the polyester acrylate graft copolymers both with poly(meth)acrylates and with polyesters, a broad spectrum of innovative formulations can be realised by adding the graft copolymers, these formulations exhibiting improved cohesion and adhesion and also enhanced attachment to a multiplicity of substrates.

Besides the polyester acrylate graft copolymers of the invention, such adhesive formulations may comprise further additives. Additives that may be mentioned include, by way of example, polymers such as, for example, copolyesters, polyacrylates, polyether polyols, ethylene-vinyl acetate, polyolefins, thermoplastic polyurethanes and/or crosslinkers such as, for example, polyisocyanates, blocked polyisocyanates, silanes and/or tackifiers such as, for example, rosins, hydrocarbon resins, phenolic resins and/or pigments and/or fillers such as, for example, talc, silicon dioxide, calcium carbonate, barium sulphate, titanium dioxide, carbon black and/or coloured pigments, flame retardants such as, for example, zinc borates, ammonium polyphosphates and/or antimony oxides, and/or ageing inhibitors and auxiliaries.

In the adhesive formulations the fraction of the polyester acrylate graft copolymers of the invention is 1% to 100% by weight, preferably 1% to 70% by weight and especially 1% to 50% by weight.

A further field of application for the polyester acrylate graft copolymers of the invention is their use in coating materials or in paints in the capacity, for example, of binders or dispersants. For a comparable molecular weight, the graft copolymers, both in solution and in the melt, exhibit significantly lower viscosities than do linear polymer architectures. Paint formulations which comprise the polyester acrylate graft copolymers of the invention as binders therefore have better processing properties and/or can be prepared with a higher solids content. On the basis of the different properties of the poly(meth)acrylate fraction and of the polyester fraction in the polyester acrylate graft copolymers, the polymers also display particularly good properties in relation to the dispersing of pigments in coating and paint formulations.

Further fields of application are, for example, formulations for cosmetic use, use as a polymer additive, or in packaging.

Hotmelt adhesives, adhesive-bonding compositions, sealants, pressure-sensitive adhesives, heat-sealing compositions, formulations for cosmetic use, coating materials, paints and packaging comprising the above-described polyester acrylate graft copolymers are likewise provided for the present invention.

Even without further remarks it is assumed that a person skilled in the art will be able to utilize the above description in its widest context. The preferred embodiments and examples are to be interpreted, therefore, merely as a descriptive disclosure which by no means has any limiting effect whatsoever.

The present invention is illustrated in more detail below with reference to examples. Alternative embodiments of the present invention are obtainable by analogy.

### EXAMPLES

General information on product characterization:

The methods listed below are used to characterize all of the polymers set out in the present invention:

The molecular weight values reported below are determined by means of gel permeation chromatography (GPC, RI detection). In these figures, M_{w} is the mass-average molecular weight, Mₙ is the number-average molecular weight, and Mₚ is the molar weight at the peak maximum. The characterization of all of the samples by gel permeation chromatography is performed in tetrahydrofuran as eluent in accordance with DIN 55672-1 against polystyrene standards. The figures are reported in g/mol.

The acid number is determined in accordance with DIN EN ISO 2114. The acid number (AN) is the amount of potassium hydroxide in mg that is needed to neutralize the acids present in one gram of substance. The sample under analysis is dissolved in dichloromethane and titrated with 0.1 N methanolic potassium hydroxide solution against phenolphthalein.

The hydroxyl number (OH number) is determined in accordance with DIN 53240-2. In this method, the sample is reacted with acetic anhydride in the presence of a 4-dimethylaminopyridine catalyst, and the hydroxyl groups are acetylated. This reaction produces one molecule of acetic acid per hydroxyl group, while the subsequent hydrolysis of the excess acetic anhydride yields two molecules of acetic acid. The consumption of acetic acid is determined by titrimetry from the difference between the main value and a blank value to be carried out in parallel.

The viscosity numbers (VN) are determined from a 0.5% strength solution in chloroform at 25° C. in accordance with DIN EN ISO 1628-1.

### Example 1

### Preparation of a poly(meth)acrylate

A jacketed vessel with attached thermostat, reflux condenser, paddle stirrer and internal thermometer is charged with 245 g of butyl acetate, 120 g of methyl methacrylate and 2.5 g of 2-hydroxyethyl methacrylate. The mixture is heated to 105° C. and then 3.1 g of 2-mercaptoethanol (in solution in 10 ml of butyl acetate) are added. Initiation takes place by addition of 3.7 g of tert-butyl perbenzoate. After 20 minutes of stirring, a mixture of 50 g of butyl acetate, 8.2 g of tert-butyl perbenzoate, 9.7 g of 2-mercaptoethanol, 361 g of methyl methacrylate and 7.5 g of 2-hydroxyethyl methacrylate is metered in over a period of four hours. After the end of metering, stirring is continued at 105° C. for 2 hours and then at 90° C. for 2 hours. Lastly the solvent is removed by distillation.

Analytical Data

Hydroxyl number: 24 mg KOH/g

Mₙ: 4800 g/mol

M_{w}: 12200 g/mol

Mₚ: 13600 g/mol

### Example 2

### Preparation of a poly(meth)acrylate

A 5 l jacketed vessel with attached thermostat, reflux condenser, stirrer and internal thermometer is used to prepare, as a suspension stabilizer, freshly precipitated Al(OH)₃, by addition to 2838 g of fully demineralized water of 7.7 g of Al₂(SO₄)₃, 0.4 g of complexing agent (Trilon A), 0.2 g of emulsifier (Emulgator K 30, available from Bayer AG), and precipitation with 64.4 g of a 10% strength aqueous soda solution. Then, with stirring, a mixture of 1867 g of methyl methacrylate, 38 g of hydroxyethyl methacrylate, 57.2 g of 3-mercapto-1-hexanol and 28.6 g of dilauryl peroxide is added. The polymerization is carried out at an internal temperature of 72° C. for 84 minutes. This is followed by an after-reaction phase of 2 hours at an internal temperature of 82° C. After cooling, the stabilizer is converted into water-soluble aluminium sulphate by addition of 50% strength sulphuric acid. The bead polymer is isolated by filtration, washed with fully demineralized water and dried in a drying cabinet at 35° C. for two days.

Analytical Data

Hydroxyl number: 22 mg KOH/g

Viscosity number: 13.7 cm³/g

### Example 3

### Preparation of a poly(meth)acrylate

A 5 l jacketed vessel with attached thermostat, reflux condenser, stirrer and internal thermometer is used to prepare, as a suspension stabilizer, freshly precipitated Al(OH)₃, by addition to 2838 g of fully demineralized water of 7.7 g of Al₂(SO₄)₃, 0.4 g of complexing agent (Trilon A), 0.2 g of emulsifier (Emulgator K 30, available from Bayer AG), and precipitation with 64.4 g of a 10% strength aqueous soda solution. Then, with stirring, a mixture of 1838 g of methyl methacrylate, 85.7 g of hydroxyethyl methacrylate, 57.2 g of n-dodecyl mercaptan and 28.6 g of dilauryl peroxide is added. The polymerization is carried out at an internal temperature of 72° C. for 84 minutes. This is followed by an after-reaction phase of 2 hours at an internal temperature of 82° C. After cooling, the stabilizer is converted into water-soluble aluminium sulphate by addition of 50% strength sulphuric acid. The bead polymer is isolated by filtration, washed with fully demineralized water and dried in a drying cabinet at 35° C. for two days.

Analytical Data

Hydroxyl number: 17 mg KOH/g

Viscosity number: 13.7 cm³/g

### Example 4

### Preparation of a Carboxyl-Bearing Polyester

Adipic acid (560.0 g, 3.8 mol) and hexane-1,6-diol (587.5 g, 5.0 mol) are melted in a stream of nitrogen in a 1 l flask with top-mounted distillation attachment. When a temperature of 160° C. is reached, water begins to distil off. Over the course of an hour the temperature is raised successively to 240° C. After a further hour at this temperature, the elimination of water becomes slower. 50 mg of titanium tetrabutoxide are stirred in, and operation continues under reduced pressure, which in the course of the reaction is adjusted so that distillate continues to be produced. When a hydroxyl number of 125 mg KOH/g and an acid number of 0.9 mg KOH/g are reached, the batch is cooled to 160° C., butanedioic anhydride (11.5 g, 1.1 mol) is added, and the mixture is stirred at this temperature for 60 minutes.

Analytical Data

Hydroxyl number: 44 mg KOH/g

Acid number: 46 mg KOH/g

Mₙ: 2100 g/mol

M_{w}: 4600 g/mol

Mₚ: 4200 g/mol

### Example 5

### Preparation of a Carboxyl-Bearing Polyester

Isophthalic acid (465.0 g, 2.8 mol), terephthalic acid (199.0 g, 1.2 mol), 1,2-ethanediol (136.0 g, 2.2 mol), 2,2′-dimethyl-1,3-propanediol (143.0 g, 1.4 mol) and 1,6-hexanediol (226.0 g, 1.9 mol) are melted in a stream of nitrogen in a 1 l flask with top-mounted distillation attachment. When a temperature of 160° C. is reached, water begins to distil off. Over the course of an hour the temperature is raised successively to 250° C. After a further hour at this temperature, the elimination of water becomes slower. 50 mg of titanium tetrabutoxide are stirred in, and operation continues under reduced pressure, which in the course of the reaction is adjusted so that distillate continues to be produced. When a hydroxyl number of 128 mg KOH/g and an acid number of 0.9 mg KOH/g are reached, the batch is cooled to 160° C., butanedioic anhydride (171.0, 1.7 mol) is added, and the mixture is stirred at this temperature for 60 minutes.

Analytical Data

Hydroxyl number: 55 mg KOH/g

Acid number: 55 mg KOH/g

Mₙ: 1900 g/mol

M_{w}: 3500 g/mol

Mₚ: 3400 g/mol

### Example 6

### Preparation of an Inventive Polyester-Acrylate Copolymer Prepared by Coupling Grafting

A 500 ml three-necked flask with distillation bridge is charged under an inert gas atmosphere with 150 g of carboxyl-bearing polyester from example 4, and this initial charge is heated to 50° C. Then 300 g of the hydroxyl-functionalized polymethacrylate from example 1 are added in the course of further heating to 200° C. The end of the addition is followed by stirring for 2 hours.

Subsequently, at this temperature, 0.05 g of butyltin tris-2-ethylhexanoate is added and slowly a reduced pressure (3 mbar) is applied. After 3 hours a product is obtained which is colourless and transparent in the melt.

Analytical Data

Hydroxyl number: 12 mg KOH/g

Acid number: 1.8 mg KOH/g

Mₙ: 7500 g/mol

M_{w}: 29500 g/mol

Mₚ: 19700 g/mol

### Example 7

### Preparation of an Inventive Polyester-Acrylate Copolymer Prepared by Coupling Grafting

A 500 ml three-necked flask with distillation bridge is charged under an inert gas atmosphere with 150 g of carboxyl-bearing polyester from example 4, and this initial charge is heated to 50° C. Then 300 g of the hydroxyl-functionalized polymethacrylate from example 2 are added in the course of further heating to 200° C. The end of the addition is followed by stirring for 2 hours.

Subsequently, at this temperature, 0.05 g of butyltin tris-2-ethylhexanoate is added and slowly a reduced pressure (1 mbar) is applied. After 5 hours a product is obtained which is pale yellow and transparent in the melt.

Analytical Data

Hydroxyl number: 7 mg KOH/g

Acid number: 1.9 mg KOH/g

Mₙ: 7200 g/mol

M_{w}: 33800 g/mol

Mₚ: 21400 g/mol

### Example 8

### Preparation of an Inventive Polyester-Acrylate Copolymer Prepared by Coupling Grafting

A 500 ml three-necked flask with distillation bridge is charged under an inert gas atmosphere with 130 g of carboxyl-bearing polyester from example 5, and this initial charge is heated to 50° C. Then 300 g of the hydroxyl-functionalized polymethacrylate from example 3 are added in the course of further heating to 200° C. The end of the addition is followed by stirring for 2 hours.

Subsequently, at this temperature, 0.05 g of butyltin tris-2-ethylhexanoate is added and slowly a reduced pressure (3 mbar) is applied. After 3 hours a product is obtained which is colourless and transparent in the melt.

Analytical Data

Hydroxyl number: 13 mg KOH/g

Acid number: 5.9 mg KOH/g

Mₙ: 4500 g/mol

M_{w}: 14700 g/mol

Mₚ: 12500 g/mol

### Comparative Example C1

### Preparation of a Non-Inventive poly(meth)acrylate

A jacketed vessel with attached thermostat, reflux condenser, paddle stirrer and internal thermometer is charged with 245 g of butyl acetate, 10.8 g of methyl methacrylate and 14.7 g of 2-hydroxyethyl methacrylate. The mixture is heated to 105° C. and then 2.4 g of n-dodecyl mercaptan (in solution in 10 ml of butyl acetate) are added. Initiation takes place by addition of 3.8 g of tert-butyl perbenzoate. After 20 minutes of stirring, a mixture of 50 g of butyl acetate, 6.6 g of tert-butyl perbenzoate, 14.0 g of n-dodecyl mercaptan, 325 g of methyl methacrylate and 44.3 g of 2-hydroxyethyl methacrylate is metered in over a period of four hours. After the end of metering, stirring is continued at 105° C. for 2 hours and then at 90° C. for 2 hours. Lastly the solvent is removed by distillation.

Analytical data

Hydroxyl number: 53 mg KOH/g

Mₙ: 6200 g/mol

M_{w}: 13900 g/mol

Mₚ: 13200 g/mol

### Comparative Example C2

### Attempt at Preparation of a Polyester-Acrylate Copolymer Prepared by Coupling Grafting

A 500 ml three-necked flask with distillation bridge is charged under an inert gas atmosphere with 150 g of carboxyl-bearing polyester from example 4, and this initial charge is heated to 50° C. Then 300 g of the hydroxyl-functionalized polymethacrylate from comparative example C1 are added in the course of further heating to 200° C. The end of the addition is followed by stirring for 2 hours. Subsequently, at this temperature, 0.05 g of butyltin tris-2-ethylhexanoate is added and slowly a reduced pressure is applied. The polymer crosslinks at 50 mbar after about 1 hour.

Characterization is not possible.

Comparative C2 shows that too high a fraction of hydroxyl groups in the poly(meth)acrylate prepolymer leads to crosslinking in the grafting reaction. Poly(meth)acrylates having an OH number of less than 40 mg KOH/g, in contrast, can surprisingly be grafted with polyesters bearing acid end groups without the product gelling in the process. It has also been possible to show that the preparation method of the prepolymer is irrelevant for the grafting reaction. Thus, for example, both solution polymers and suspension polymers can be used. With the examples it is possible to show, furthermore, that the composition of the poly(meth)acrylates and of the polyesters is freely selectable and hence the properties of the copolymers can be set in a targeted way.

1. A polyester acrylate graft copolymer comprising a poly(meth)acrylate as graft substrate, the graft substrate having an internal and/or terminal functional group and a polyester side chain as a graft branch and/or having polyester block attached to at least one chain end of the graft substrate.

2. The polyester acrylate graft copolymer according to claim 1, wherein the poly(meth)acrylate comprises at least one monomer comprising a functional group.

3. The polyester acrylate graft copolymer according to claim 1, wherein the functional group is selected from the group consisting of a hydroxyl group, an acid group, an amino group and a mercapto group.

4. The polyester acrylate graft copolymer according to claim 1, wherein the amount of monomers with functional groups is in the range from 0.1% to 10% by weight, based on the poly(meth)acrylate fraction in the polyester acrylate graft copolymer.

5. A process for preparing a polyester acrylate graft copolymer according to claim 1, comprising coupling grafting a polyester to a graft substrate, the graft substrate comprising a poly(meth)acrylate having an internal and/or terminal functional group, and forming a polyester side chain as a graft branch and/or forming a polyester block attached to at least one chain end of the graft substrate.

6. The process according to claim 5, wherein the polyester comprises a hydroxyl groups and/or carboxyl groups.

7. The process according to claim 5, wherein the polyester acrylate graft copolymer is obtained by a process comprising reacting the polyester with a poly(meth)acrylate in an inert gas atmosphere in the melt or in azeotropic regime.

8. The process according to claim 5, wherein the amount of polyester is between 10 and 90 parts by weight, based on the polyester acrylate graft copolymer.

9. (canceled)

10. A hotmelt adhesive, adhesive-bonding composition, sealant, pressure-sensitive adhesive, heat-sealing composition, cosmetic formulation, coating material, paint, or packaging comprising the polyester acrylate graft copolymer according to claim 1.
